(19) United States
(12) Patent Application Publication
(10) Pub. No.: US 2025/0084924 A1
(43) Pub. Date: Mar. 13, 2025

(54) SLIDE RING COMPRISING WEAR-MEASURING DEVICE AND MECHANICAL SEAL ASSEMBLY COMPRISING SLIDE RING OF THIS KIND

(71) Applicant: EagleBurgmann Germany Gmbh & Co, KG, Wolfratshausen (DE)

(72) Inventors: Joachim Otschik, Murnau (DE); Stefanie Kreft, München (DE); Robert Suszniak, Münsing (DE)

(73) Assignee: EagleBurgmann Germany Gmbh & Co, KG, Wolfratshausen (DE)

(21) Appl. No.: 18/697,861

(22) PCT Filed: Oct. 6, 2022
(86) PCT No.: PCT/EP2022/077783

§ 371 Date: Apr. 2, 2024

(30) Foreign Application Priority Data
Oct. 19, 2021 (DE) 102021127019.7

(51) Int. Cl. F16J 15/34

(52) U.S. Cl. CPC F16J 15/3492

(57) ABSTRACT

The invention relates to a stationary slide ring of a mechanical seal assembly, comprising a main body (41) having a slide surface (40) and a wear-measuring device (6) arranged on the main body (41) to detect wear of the slide surface (40) of the stationary slide ring on the basis of a change in an electrical variable, wherein the wear-measuring device (6) comprises an electrical voltage source (60), a measuring region (6a) on the slide surface (40), an electrical feed line (61), which electrically connects the voltage source (60) to the measuring region (6a), and an electrical return line (62), which electrically connects the measuring region (6a) to the voltage source (60), and wherein the measuring region (6a) is arranged in a recess (42) in the slide surface (40).

The invention relates to a stationary slide ring of a mechanical seal assembly comprising a wear-measuring device and to a mechanical seal assembly comprising a stationary slide ring of this kind.

Mechanical seals are known from the prior art in different configurations. Although mechanical seals are operated without contact as a rule during operation because there is a gas or a liquid between the slide rings in the sealing gap, contact with the slide surfaces occurs when starting up and switching off a device sealed by the mechanical seal. In addition, contact with the slide surfaces can occur during operation owing to external influencing factors, and this results in wear of the slide surfaces and possibly in parts needing to be replaced. Since, in the worst case, the mechanical seal can fail and the medium to be sealed can leak out as a result of the wear, where possible worn slide rings should be replaced before they completely fail. However, they should not be replaced too soon, either, since slide rings are very expensive components.

Therefore, the object addressed by the present invention is to provide a slide ring and a mechanical seal assembly which, while having a simple construction and being simple and cost-effective to produce, comprises a wear-measuring device in order to detect wear of the slide ring with a high level of accuracy.

This object is achieved by a stationary slide ring of a mechanical seal assembly having the features of claim 1 and by a mechanical seal assembly having the features of claim 11. The dependent claims disclose preferred developments of the invention.

The stationary slide ring of a mechanical seal assembly having the features of claim 1 provides the advantage that it is possible to reliably detect wear of the stationary slide ring on its slide surface. In particular, in the stationary slide ring according to the invention, current wear can also be identified in a simple and reliable manner. Therefore, in the stationary slide ring according to the invention, not only can it be detected that a defined wear limit has been reached, but it is also possible for the existing wear to be detected continuously over the duration of use of the stationary slide ring until the wear limit is reached. At the same time, the stationary slide ring still has a simple and cost-effective construction. According to the invention, this is achieved in that the stationary slide ring comprises a main body having a slide surface and a wear-measuring device. The wear-measuring device is arranged on the main body. The wear-measuring device is configured to detect current wear of the stationary slide ring on its slide surface on the basis of a change in an electrical variable. Here, the wear-measuring device comprises an electrical voltage source, a measuring region on the slide surface of the stationary slide ring, an electrical feed line, which electrically connects the voltage source to the measuring region, and an electrical return line, which electrically connects the measuring region to the voltage source. Here, the measuring region of the wear-measuring device is arranged in a recess in the slide surface of the stationary slide ring. The measuring region thus closes the electrical circuit from the voltage source via the feed line and the return line. When wear of the slide surface then occurs, the measuring region is also accordingly subjected to wear. As a result, however, e.g. the electrical resistance at the measuring region changes, because the measuring region arranged in the recess becomes thinner due to the wear. Here, the change in the resistance is substantially proportional to the material removed by wear. As a result, the wear occurring on the slide surface of the stationary slide ring can thus be very accurately determined by detecting the change in the electrical resistance of the circuit. Changes in other electrical variables can also be measured here.

The recess in the slide surface of the stationary slide ring is preferably completely filled with an electrically conductive material. In this case, the surface of the electrically conductive material that is on the outside in the recess is planar relative to the slide surface of the main body of the stationary slide ring. This ensures that the wear can be continually detected starting from a new slide ring over the entire service life of the slide ring.

The electrically conductive material in the recess is preferably titanium nitride. More preferably, the stationary slide ring is made of a carbide material, in particular SiC or WC, with the carbide material being adapted such that it does not have any electrical conductivity, or only minimal electrical conductivity.

The depth of the recess is preferably selected such that, when there is wear down to the bottom of the recess, a wear limit of the stationary slide ring is reached. When the material in the recess has thus been fully removed by wear, the electrical circuit of the wear-measuring device is broken, which is an easily detectable indicator of a predetermined wear limit of the stationary slide ring being reached.

In order for there to be the most even wear possible in the measuring region in the recess, the recess is preferably formed as a curved groove.

More preferably, the electrical feed line is guided through a first hole in the main body of the stationary slide ring to the measuring region and/or the electrical return line is guided through a second hole in the main body of the stationary slide ring. The first hole and the second hole are preferably arranged on the same radius.

It is particularly preferable here for an electrically conductive filler material to be arranged in the first hole and/or the second hole in the main body, the filler material completely filling the first and/or the second hole. Silver is preferably used as the electrically conductive filler material.

More preferably, a width of the recess is greater than or equal to a diameter of the first and/or second hole. The diameter of the first and second hole is preferably identical; in particular, the diameter of the first and second hole is 1 mm±10% in each case.

More preferably, the curved recess is arranged on a circumferential portion of the slide surface that is in the center in the radial direction.

In order to prevent the stationary slide ring from having an imbalance or an undulating shape or another kind of geometric deformation due to the wear-measuring device being provided, a second wear-measuring device is preferably arranged on the main body which is arranged opposite the first wear-measuring device at 180°. Alternatively, three wear-measuring devices or four wear-measuring devices can also be provided at equal circumferential spacing on the stationary slide ring. All the measuring devices are preferably identical.

Furthermore, the present invention relates to a mechanical seal assembly comprising a mechanical seal having a rotating slide ring and a stationary slide ring according to the invention. The slide rings have a sealing gap between their slide surfaces and the mechanical seal assembly further comprises an automated measuring unit, which is configured to determine wear of the slide surface of the stationary slide ring. Here, the wear is determined by measuring electrical variables, in particular an electrical resistance, of the electrical circuit integrated in the stationary slide ring, and a conclusion is drawn on wear of the stationary slide ring on the basis of a comparison with stored comparative data. These stored comparative data can be data which have been detected on a test bench and/or data which have been detected during operation of mechanical seals. In particular, the stored comparative data can be continually updated by adding new data from the operation of mechanical seals.

The automated measuring unit preferably detects the electrical variables, in particular the electrical resistance, which are detected to determine the wear, either continuously or at relatively short intervals, for example half-hourly or hourly during normal operation of the mechanical seal assembly.

Therefore, by means of the present invention, wear of the stationary slide ring can be determined at any desired point in time. On the basis of the wear of the stationary slide ring, a conclusion can then be drawn on the wear of the entire mechanical seal and, where necessary, this can trigger replacement of the slide rings. Therefore, a sudden malfunction of the mechanical seal can be prevented with a high level of reliability, and therefore, in particular when sealing against media that are hazardous to the environment, sudden failure of the mechanical seal and therefore a potential leak of the hazardous medium can be prevented. Replacement of the slide rings is preferably triggered before the defined maximum wear limit is reached, such that a user of the mechanical seal assembly, for example in a large system, can also plan the replacement of the slide rings.

In the following, preferred exemplary embodiments of the invention will be described in detail with reference to the accompanying drawings, in which:

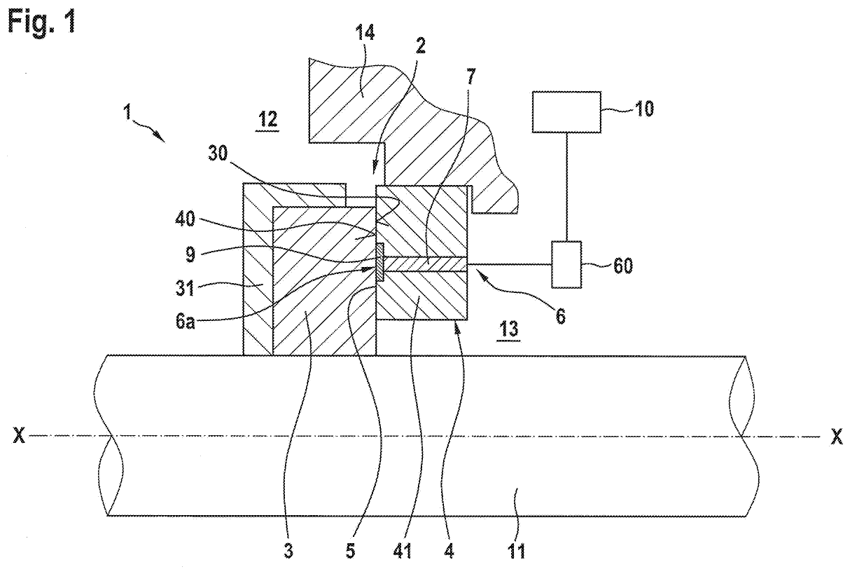

FIG. 1 is a schematic sectional view of a mechanical seal assembly comprising a stationary slide ring according to a first exemplary embodiment of the present invention,

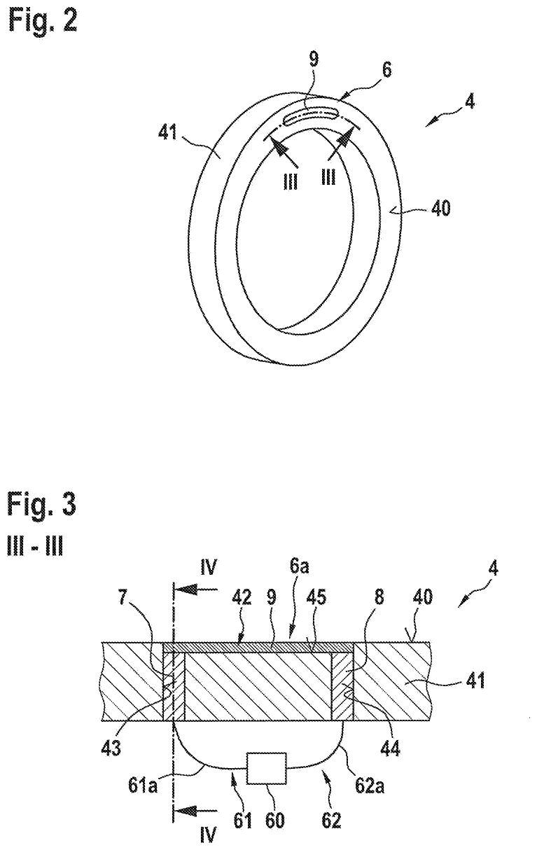

FIG. 2 is a schematic perspective view of the stationary slide ring from FIG. 1,

FIG. 3 is a schematic sectional view of the stationary slide ring along the line III-III from FIG. 2,

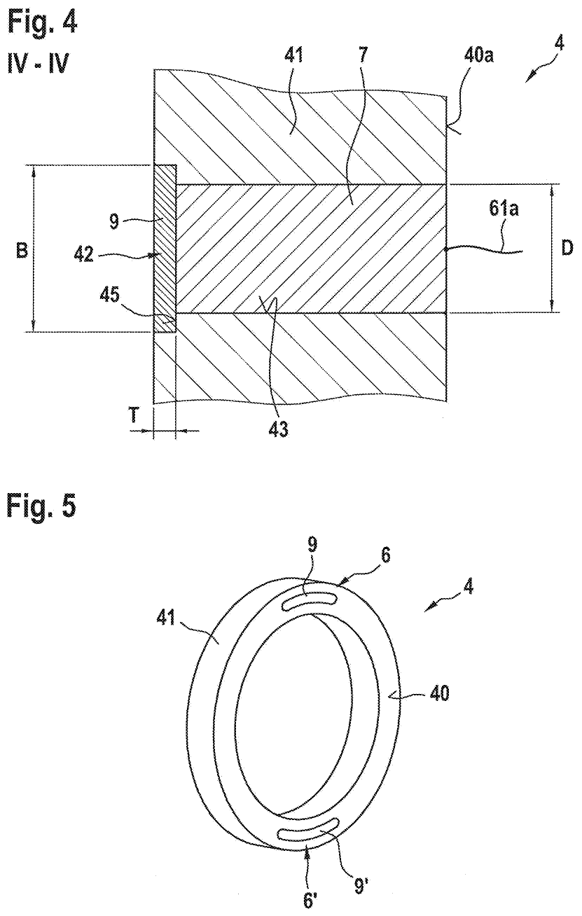

FIG. 4 is a schematic enlarged cross-sectional view of the stationary slide ring along the line IV-IV from FIG. 3, and

FIG. 5 is a schematic perspective view of a stationary slide ring according to a second exemplary embodiment of the present invention.

In the following, with reference to FIGS. 1 to 4, a mechanical seal assembly 1 comprising a stationary slide ring 4 according to a first exemplary embodiment of the invention is described in detail.

As shown in FIG. 1, the mechanical seal assembly 1 comprises a mechanical seal 2 comprising a rotating slide ring 3 and the stationary slide ring 4. A sealing gap 5 is defined between a slide surface 30 of the rotating slide ring 3 and a slide surface 40 of the stationary slide ring 4.

Here, the mechanical seal 2 seals a product region 12 from an atmosphere region 13 on a shaft 11. The rotating slide ring 3 is connected to the shaft 11 by means of a slide ring carrier 31.

The stationary slide ring 4 is arranged on a stationary housing 14.

The stationary slide ring 4 is shown in detail in FIGS. 2 to 4. Here, the stationary slide ring 4 comprises a main body 41, on which the slide surface 40 directed towards the rotating slide ring 3 is formed.

Furthermore, the stationary slide ring 4 comprises a wear-measuring device 6. The wear-measuring device 6 is arranged on the main body 41 and is configured to detect current wear of the stationary slide ring 4 of the mechanical seal 2. The wear is detected on the slide surface 40 of the stationary slide ring 4 here.

Here, the wear-measuring device 6 comprises an electrical voltage source 60, a measuring region 6a on the slide surface 40 of the stationary slide ring, an electrical feed line 61 and an electrical return line 62. The electrical feed line 61 connects the voltage source 60 to the measuring region 6a. The electrical return line 62 connects the measuring region 6a to the voltage source 60.

Therefore, an electrical circuit is integrated in the stationary slide ring 4, the measuring region 6a being arranged on the slide surface 40.

As shown in detail in FIGS. 3 and 4, a curved recess 42 (cf. FIG. 2) is formed in the slide surface 40. The curved recess 42 is completely filled with an electrically conductive material 9, in particular titanium nitride. A surface of the measuring region 6a is planar relative to the slide surface 40 of the stationary slide ring 4 here, as shown in FIG. 3.

As also shown in FIG. 3, a first hole 43 and a second hole 44 is formed in the main body 41 of the stationary slide ring 4. In this case, the first and second hole 43, 44 are formed such that each hole is arranged in an end region of the curved recess 42 (cf. FIG. 3). The first and second hole 43, 44 are completely guided through the main body 41 as far as a rear face 40a here. The two holes 43, 44 are guided through the main body 41 in a straight line in parallel with an axial direction X-X of the mechanical seal assembly 1.

As also shown in particular in FIG. 3, the first hole 43 is completely filled with a first conductive filler material 7. The first electrically conductive filler material 7 is connected to the electrical voltage source 60 by means of a line portion 61a on the rear face 40a of the stationary slide ring 4. In the same way, the second hole 44 is also filled with a second electrically conductive filler material 8, which is connected to the electrical voltage source 60 by means of a line portion 62a of the return line 62.

The first and second filler material 7, 8 is preferably the same material, in particular silver. Silver has the advantage that it has very good electrical conductivity and can be relatively easily introduced into and hardened in the holes 43, 44. Furthermore, simple connection of the line portions 61a, 62a of the feed line and the return line of the wear-measuring device 6 can also be ensured.

The first and second holes 43, 44 are preferably identical and have a diameter D. As shown in particular in FIG. 4, the curved recess 42 has a width B which is greater than the diameter D of the holes 43, 44. In this case, the recess 42 has a depth T of at most 10 μm, particularly preferably at most 5 μm. The diameter D of the first and second hole is preferably 1 mm.

The depth T of the recess 42 is selected such that, when the bottom 45 of the recess 42 is reached, the maximum wear of the slide surface 40 of the stationary slide ring 4 has been reached.

The material of the stationary slide ring 4 is preferably an electrically non-conductive ceramic. It should be noted that a material which has considerably poorer electrical conductivity than the filler materials 7, 8 of the wear-measuring device 6 is also used as the material for the stationary slide ring 4. A silicon-carbide-containing material is preferably used as the material for the stationary slide ring.

The material 9 in the recess 42 is preferably introduced into the recess 42 by means of a coating process, for example a PVD process. Since this often also partially coats regions of the slide surface 40 around the recess 42, in a further step a surface treatment of the slide surface 40 is also carried out to remove this coating that is protruding from the recess 42.

Therefore, the wear-measuring device 6, which thus has a first resistance value as the electrical variable in the new state when a voltage is applied, is then integrated in the stationary slide ring 4. After the mechanical seal 2 is installed to seal against the shaft 11, wear then occurs to the slide surfaces 30, 40 of the slide rings 3, 4 during operation. In this process, however, wear also occurs to the material 9 arranged in the recess 42. As a result, however, the electrical resistance of the circuit of the wear-measuring device 6 changes since removal of the material 9 results in a reduced cross section in the measuring region 6a.

It has been found that there is a clear link between the changing resistance in the measuring region 6a and the wear of the measuring region due to removal of material 9 from the surface of the measuring region. This can then be used to determine wear of the slide surface 40 of the stationary slide ring 4. The smaller the cross section of the material 9 in the recess 42 owing to increasing wear of the slide surface 40, the greater a resistance value of the electrical circuit of the wear-measuring device 6.

By means of an automated measuring unit 10 (cf. FIG. 1), which is configured to determine the wear of the slide surface 40 of the stationary slide ring 4, wear of the slide surface 40 can thus be ascertained at any point in time by simply applying a voltage to the circuit integrated in the stationary slide ring 4. It is possible here for a voltage to be continuously applied or, alternatively, for the measurement to be determined at intervals, for example hourly or daily or at any other interval, depending on the operating conditions of the mechanical seal 2.

Therefore, according to the invention, there is the option to determine wear of the slide surface 40 of the stationary slide ring 4 with maximum reliability. It is also possible here to also infer wear of the rotating slide ring 3 on the basis of the determined wear of the slide surface 40 of the stationary slide ring 4. Therefore, maintenance and, for example, replacement of the slide rings can be planned in good time, without a complete malfunction occurring owing to failure of the mechanical seal 2, which occurs with increasing wear. As a result, a user can plan maintenance of the mechanical seal, which can then be carried out at the most convenient point in time for the user.

In this case, the depth T of the recess 42 and thus the cross section of the material 9 in the measuring region 6a is preferably selected such that the depth T corresponds to the maximum permissible wear of the slide surface 40 of the stationary slide ring 4. If wear has thus progressed so far that the material 9 in the recess 42 has completely worn down to the bottom 45, the circuit is broken and this therefore clearly indicates that the maximum wear limit of the stationary slide ring 4 has been reached.

FIG. 5 shows a stationary slide ring 4 of a mechanical seal assembly according to a second exemplary embodiment of the invention. Identical or functionally identical parts are provided with the same reference signs as in the first exemplary embodiment. Unlike in the first exemplary embodiment, in the second exemplary embodiment a first wear-measuring device 6 and a second wear-measuring device 6′ are provided. As is shown in FIG. 5, in this case a separate measuring region containing electrically conductive material 9, 9′ is provided in each recess for each wear-measuring device 6, 6′. The two wear-measuring devices 6, 6′ are opposite one another at 180° on the circumference of the stationary slide ring 4. This in particular ensures that any imbalance or undesired undulating shapes which could occur due to providing the wear-measuring device 6 in the region of the slide surface 40 can be compensated for. It should also be noted that an alternative configuration can also be provided in that three wear-measuring devices 6 are provided at equal spacing over the circumference or four wear-measuring devices 6 can be provided at equal circumferential spacing over the circumference. Otherwise, this exemplary embodiment corresponds to the first exemplary embodiment, and therefore reference can be made to the description of that exemplary embodiment.

As set out in the exemplary embodiments, a mechanical seal assembly can thus be provided which allows for anticipatory maintenance of the mechanical seal assembly. In this case, a wear state can be carried out continuously or at preselected intervals during operation of the mechanical seal assembly. As a result, slide rings of the mechanical seal assembly can be replaced in good time, such that a sudden, undesired complete malfunction of the mechanical seal assembly, which usually results in a complete stop of a machine in which the mechanical seal assembly is providing sealing, can be prevented.

### LIST OF REFERENCE CHARACTERS

1 Mechanical seal assembly
2 Mechanical seal
3 Rotating slide ring
4 Stationary slide ring
5 Sealing gap
6 Wear-measuring device
6′ Second wear-measuring device
6a Measuring region
7 First electrically conductive filler material
8 Second electrically conductive filler material
9, 9′ Electrically conductive material in recess
10 Automated measuring unit
11 Shaft
12 Product region
13 Atmosphere region
14 Housing
30 Slide surface of the rotating slide ring
31 Slide ring carrier
40 Slide surface of the stationary slide ring
40a Rear face
41 Main body
42 Curved recess
43 First hole
44 Second hole
45 Bottom of the recess
60 Electrical voltage source
61 Feed line
61a Line portion
62 Return line
62a Line portion
B Width
D Diameter of the holes
T Depth of the recess
X-X Axial direction

1. Stationary slide ring of a mechanical seal assembly, comprising:
a main body having a slide surface and
a wear-measuring device arranged on the main body to detect wear of the slide surface of the stationary slide ring on the basis of a change in an electrical variable,
wherein the wear-measuring device includes an electrical voltage source, a measuring region on the slide surface, an electrical feed line, which electrically connects the voltage source to the measuring region, and an electrical return line, which electrically connects the measuring region to the voltage source, and
wherein the measuring region is arranged in a recess in the slide surface.

2. Stationary slide ring according to claim 1, wherein the recess is completely filled with an electrically conductive material.

3. Stationary slide ring according to claim 1, wherein a depth of the recess is selected such that, when the bottom of the recess is reached, the maximum permissible wear of the slide surface of the stationary slide ring has been reached.

4. Stationary slide ring according to claim 1, wherein the recess is a curved groove.

5. Stationary slide ring according to claim 1, wherein the electrical feed line is guided through a first hole in the main body and/or wherein the electrical return line is guided through a second hole in the main body.

6. Stationary slide ring according to claim 5, wherein the first hole and the second hole are arranged on the slide surface on the same radius.

7. Stationary slide ring according to claim 5, wherein the electrical feed line is provided in the region of the first hole by a first electrically conductive filler material, wherein the first filler material completely fills the hole, and/or wherein the electrical return line is provided in the region of the second hole by a second electrically conductive filler material, wherein the second filler material completely fills the second hole.

8. Stationary slide ring according to claim 5, wherein a width of the recess is greater than or equal to a diameter of the first and second hole.

9. Stationary slide ring according to claim 4, wherein the recess lies on a circumferential portion of the slide surface that is in the center in the radial direction of the stationary slide ring.

10. Stationary slide ring according to claim 1, comprising
a first wear-measuring device and a second wear-measuring device, which is opposite the first wear-measuring device at 180°.

11. Mechanical seal assembly, comprising:
a mechanical seal including a rotating slide ring and a stationary slide ring according to claim 1, wherein a sealing gap is defined between a slide surface of the rotating slide ring and a slide surface of the stationary slide ring, and comprising an automated measuring unit, which is configured to determine wear of the slide surface of the stationary slide ring on the basis of a change in electrical variables, in particular an electrical resistance, in a measuring region of a wear-measuring device on the slide surface of the stationary slide ring.

12. Mechanical seal assembly according to claim 11, wherein the automated measuring unit is configured to carry out the wear determination continuously or in predetermined intervals.
